(19) United States
(12) Patent Application Publication
(10) Pub. No.: US 2003/0168523 A1
(43) Pub. Date: Sep. 11, 2003

(54) Sprinkling device having light device

(76) Inventor: Huai Yao Lin, Chang Hua (TW)

Correspondence Address: Huai Yao LIN, 7F, No. 46, Pin Ho 10 Street, Chang Hua, 500, TW

(21) Appl. No.: 10/087,802

(22) Filed: Mar. 5, 2002

(51) Int. Cl. B05B 3/06

(52) U.S. Cl. 239/251; 239/279

(57) ABSTRACT

A sprinkling device includes a tube coupled to a water reservoir, a sprayer head rotatably attached to the tube with a housing and rotatable relative to the tube by the water from the tube and flowing out through the sprayer head to form a sprinkling water. A light device is disposed in the housing for lighting the sprinkling water and for generating a lighted water screen and for decorative purposes. The lighted sprinkling water may be used for warning people nearby and for preventing the people from being wetted by the sprinkling water.

### BACKGROUND OF THE INVENTION

1. Field of the Invention

The present invention relates to a sprinkling device, and more particularly to a sprinkling device having a light device for lighting the sprinkling water and for preventing people from being wetted by the sprinkling water.

2. Description of the Prior Art

Various kinds of typical sprinkling devices have been developed and comprise one or more ports for spraying or sprinkling purposes. However, whiling spraying or sprinkling the water in the dark area or during the night, people nearby may not clearly see the spraying or sprinkling water and may thus be wetted by the water inadvertently.

The present invention has arisen to mitigate and/or obviate the afore-described disadvantages of the conventional sprinkling devices.

### SUMMARY OF THE INVENTION

The primary objective of the present invention is to provide a sprinkling device including a light device for lighting the sprinkling water and for warning people nearby and for preventing the people from being wetted by the sprinkling water.

The other objective of the present invention is to provide a sprinkling device including a light device for lighting the spraying or sprinkling water and for generating a lighted water screen and for decorative purposes.

In accordance with one aspect of the invention, there is provided a sprinkling device comprising a tube for receiving water from a water reservoir, a sprayer head rotatably attached to the tube and rotatable relative to the tube by the water from the tube and flowing out through the sprayer head to provide a sprinkling water, and means for lighting the sprinkling water and for generating a lighted water screen and for decorative purposes. The lighted sprinkling water may be used for warning people nearby and for preventing the people from being wetted by the sprinkling water.

A pipe is further provided and secured on the tube, a housing is rotatably secured onto the pipe, the sprayer head is secured on the housing.

The lighting means includes at least one light device attached to the housing, and means for energizing the light device.

The energizing means includes a magnet secured on the pipe, and a coil secured in the housing and disposed around the magnet and coupled to the light device for generating electricity to energize the light device when the housing is rotated relative to the pipe and the tube.

A base is further provided for supporting the tube, the tube includes an upper end and a lower end, a conduit includes a first end secured to the lower end of the tube and a second end for coupling to the water reservoir.

The sprayer head includes at least one duct extended radially outward therefrom and having a longitudinal axis and having a bent outer end inclined relative to the duct and the longitudinal axis of the duct, for allowing the sprinkling water to propel the sprayer head to rotate relative to the tube.

The duct includes at least one orifice formed therein and directing away from the longitudinal axis of the duct, for further propelling the sprayer head to rotate relative to the tube.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial perspective view of a sprinkling device in accordance with the present invention;

FIG. 2 is a partial exploded view of the sprinkling device, in which a portion of the sprinkling device has been cut off for showing the inner structure of the sprinkling device;

FIG. 3 is a further partial exploded view of the sprinkling device;

FIG. 4 is a cross sectional view taken along lines 4-4 of FIG. 1; and

FIG. 5 is a top plan view illustrating the operation of the sprinkling device.

### DETAILED DESCRIPTION OF THE PREFERRED EMBODIMENT

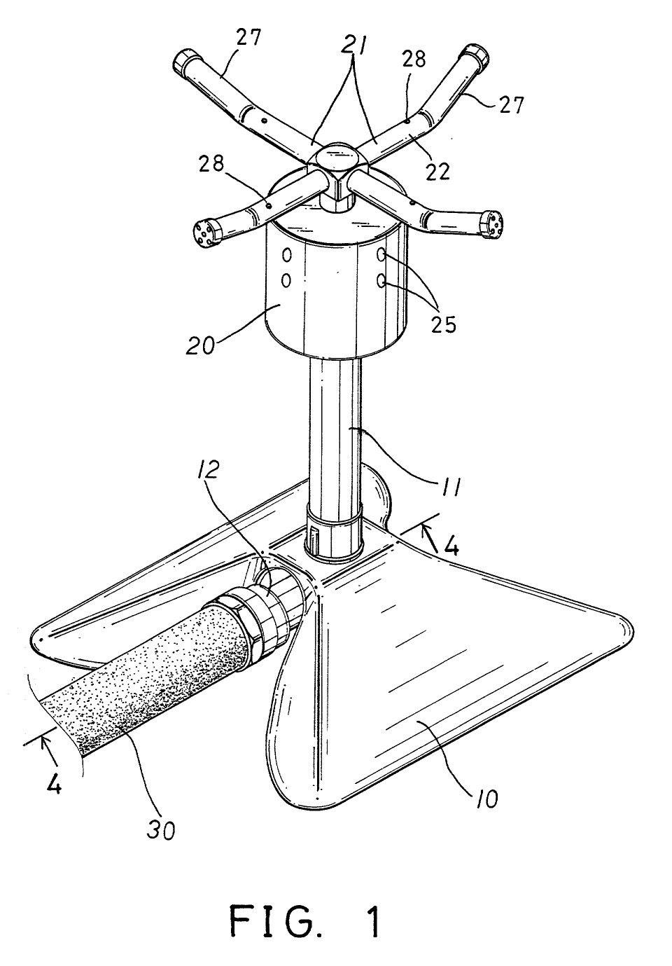

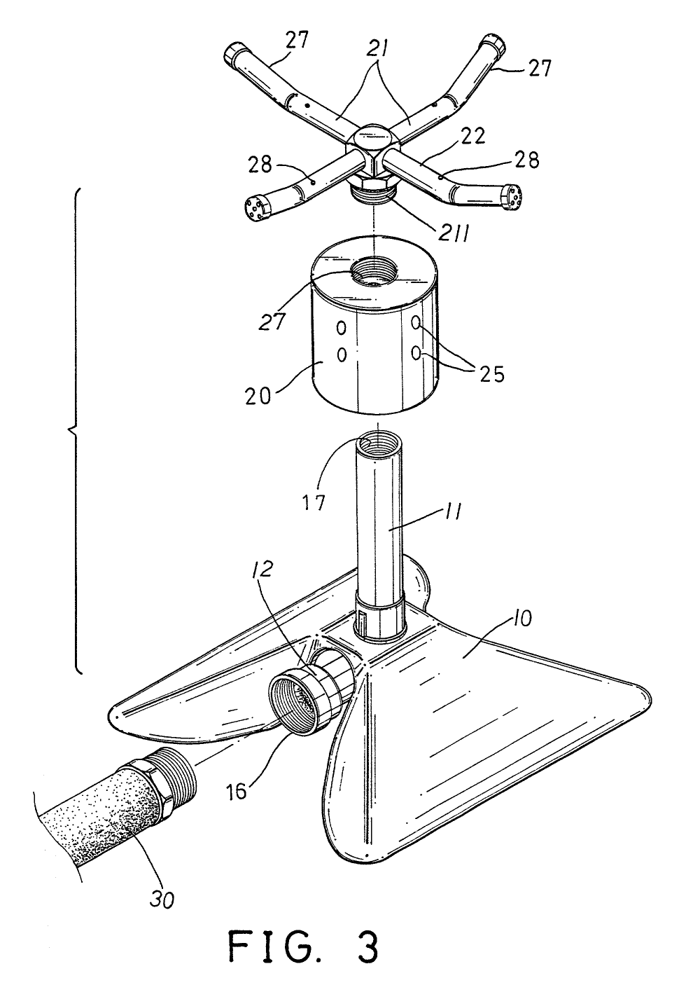

Referring to the drawings, and initially to FIGS. 1-4, a sprinkling device in accordance with the present invention comprises a base 10 including a tube 11 disposed thereon and extended upward therefrom and having an inner thread 17 formed in the upper portion thereof, a conduit 12 including an L-shape and including one end 15 secured to the lower end of the tube 11, and the other end 16 secured to a hose 30 which may be coupled to a water supplier or a water reservoir for supplying water into the tube 11.

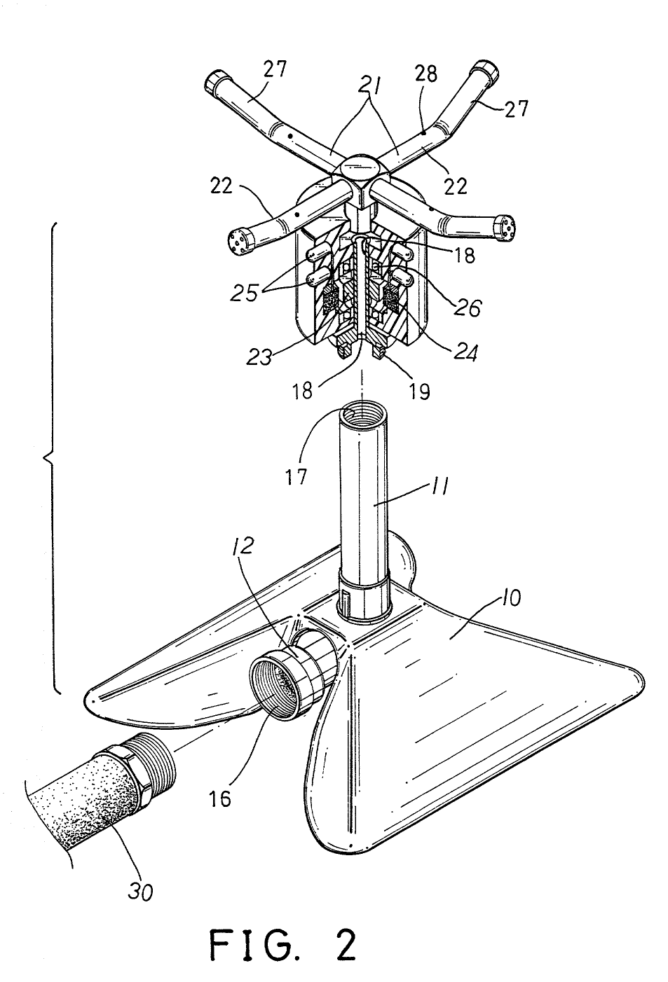

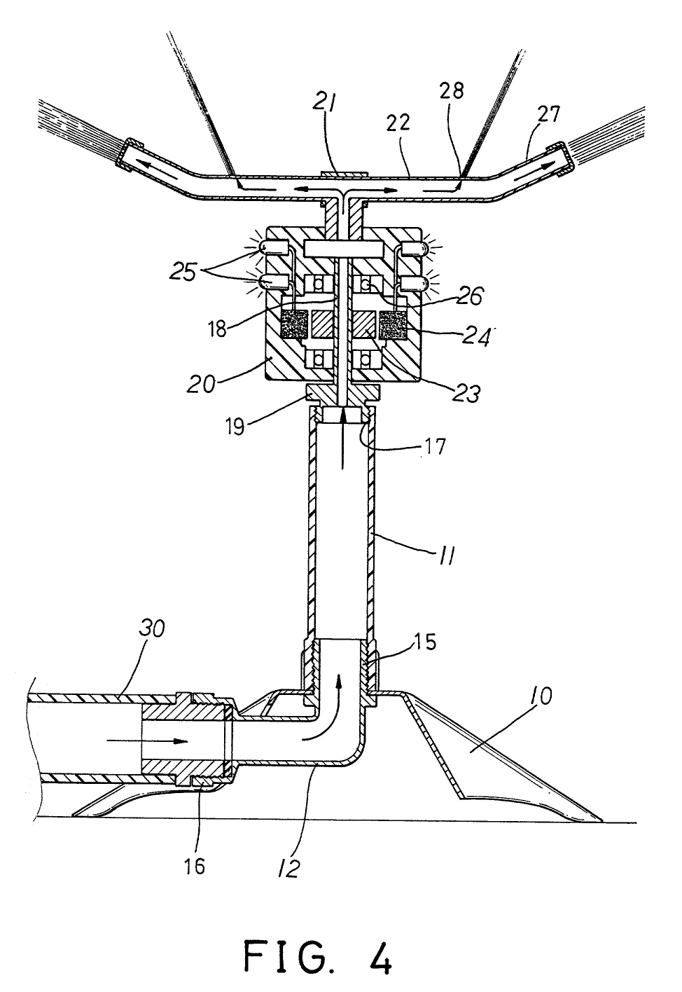

As shown in FIGS. 2, 4, a pipe 18 includes a lower portion 19 secured to the tube 11, with such as a threading engagement, for receiving the water from the tube 11. A housing 20 is rotatably secured onto the pipe 18 with one or more bearings 26, for allowing the housing 20 to be rotated relative to the pipe 18 and the tube 11. A sprayer head 21 is secured to the housing 20 and rotated in concert with the housing 20 relative to the pipe 18 and the tube 11.

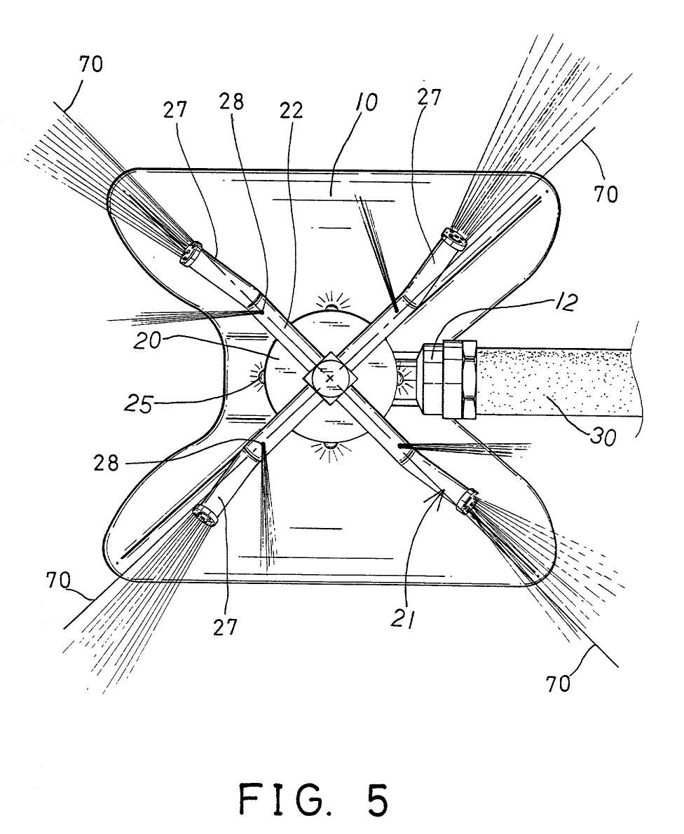

As shown in the drawings, the sprayer head 21 may include one or more ducts 22 extended radially outward therefrom and communicating with the pipe 18 for receiving the water from the pipe 18 and the tube 11. As best shown in FIG. 5, the ducts 22 each includes a bent outer end 27 offset from the longitudinal axis 70 of the ducts 22, or inclined relative to the ducts 22 for allowing the spraying water to be inclined or offset from the longitudinal axis 70 of the ducts 22. The spraying water may thus apply a force, such as a reactive force against the bent outer ends 27 of the ducts 22, in order to propel or to rotate the sprayer head 21 and the housing 20 relative to the pipe 18 and the tube 11.

As also best shown in FIG. 5, the ducts 22 themselves may each further include one or more orifices 27 opened or directing away from the longitudinal axis 70 of the ducts 22, for further allowing the spraying water to be inclined or offset from the longitudinal axis 70 of the ducts 22, and in order to further propel or to further rotate the sprayer head 21 and the housing 20 relative to the pipe 18 and the tube 11.

Referring again to FIGS. 2 and 4, a core or a magnet 23 is secured to the pipe 18. A coil 24 is secured in the housing 20 and disposed around the magnet 23, and rotatable around the magnet 23 to generate electricity when the housing 20 is rotated relative to the pipe 18. One or more light devices 25, such as the light bulbs, the light emitting diodes, or the other luminous devices, are secured in the housing 20 and partially exposed or extended outward of the housing 20. The light devices 25 are coupled to the coil 24 for being energized by the magnet 23 and the coil 24 and for lighting the water sprayed out of the ducts 22. The light devices 25 may also be energized by batteries (not shown) that may be disposed in the housing 20.

In operation, as shown in FIGS. 4 and 5, the water from the hose 30 and the tube 11 and the pipe 18 may flow out through the ducts 22 in order to propel and rotate the sprayer head 21 and the housing 20 relative to the pipe 18 and the tube 11, for spraying purposes. The light devices 25 may be energized by the magnet 23 and the coil 24 in order to light the water sprayed out of the ducts 22, for decorative purposes. People may see and view the lighted spraying or sprinkling water and may thus be prevented from being wetted by the spraying or sprinkling water.

Accordingly, the sprinkling device in accordance with the present invention includes a light device for lighting the sprinkling water and for warning people nearby and for preventing the people from being wetted by the sprinkling water. The light device may also be used to light the spraying or sprinkling water in order to generate a lighted water screen, for decorative purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprinkling device comprising:
a tube for receiving water from a water reservoir,
a sprayer head rotatably attached to said tube and rotatable relative to said tube by the water from said tube and flowing out through said sprayer head to provide a sprinkling water, and
means for lighting the sprinkling water.

2. The sprinkling device according to claim 1 further comprising a pipe secured on said tube, a housing rotatably secured onto said pipe, said sprayer head being secured on said housing.

3. The sprinkling device according to claim 2, wherein said lighting means includes at least one light device attached to said housing, and means for energizing said at least one light device.

4. The sprinkling device according to claim 3, wherein said energizing means includes a magnet secured on said pipe, and a coil secured in said housing and disposed around said magnet and coupled to said at least one light device for generating electricity to energize said at least one light device when said housing is rotated relative to said pipe and said tube.

5. The sprinkling device according to claim 1 further comprising a base, said tube being secured on said base and extended upward from said base and including an upper end and a lower end, a conduit including a first end secured to said lower end of said tube and a second end for coupling to the water reservoir.

6. The sprinkling device according to claim 1, wherein said sprayer head includes at least one duct extended radially outward therefrom and having a longitudinal axis and having a bent outer end inclined relative to said at least one duct and said longitudinal axis of said at least one duct, for allowing the sprinkling water to propel said sprayer head to rotate relative to said tube.

7. The sprinkling device according to claim 6, wherein said at least one duct includes at least one orifice formed therein and directing away from said longitudinal axis of said at least one duct, for further propelling said sprayer head to rotate relative to said tube.
